(19) United States
(12) Patent Application Publication
(10) Pub. No.: US 2018/0107744 A1
(43) Pub. Date: Apr. 19, 2018

(54) EXPLORATORY SEARCH

(71) Applicants: UNIVERSITY OF HELSINKI, Helsingin Yliopisto (FI); AALTO UNIVERSITY FOUNDATION, Espoo (FI)

(72) Inventors: Khalil KLOUCHE, Helsinki (FI); Tuukka RUOTSALO, Helsinki (FI); Giulio JACUCCI, Espoo (FI); Salvatore ANDOLINA, Helsinki (FI)

(21) Appl. No.: 15/561,693

(22) PCT Filed: Mar. 27, 2015
(86) PCT No.: PCT/FI2015/050217

§ 371 Date: Sep. 26, 2017

(51) Int. Cl. G06F 17/30; H04L 29/06

(52) U.S. Cl. CPC G06F 17/30867; H04L 29/06095; G06F 17/30905

(57) ABSTRACT

Explorative searching method, apparatus and computer programs are presented. A first explorative search is run in a first branch. A first group of entities relating to the first explorative search is presented to a user. A second explorative search is run in a second branch in parallel with the first branch. A second group of entities relating to the second explorative search is presented to the user simultaneously with the presenting of the first group of entities. The user is allowed to import one or more entities of either one of the first and second explorative searches to the remaining one of the first and second explorative searches and updating said remaining explorative search.

### TECHNICAL FIELD

The aspects of the disclosed embodiments generally relate to exploratory search. The aspects of the disclosed embodiments relate particularly, though not exclusively, to exploratory search in two or more parallel branches.

### BACKGROUND ART

This section illustrates useful background information without admission of any technique described herein representative of the state of the art. In particular, this section may identify thus far undisclosed problems with the prior art.

Most available tools for information retrieval focus on lookup retrieval, such as looking up the size of a monument or reminding a fact about a celebrity, while many users search to solve more complex tasks that require exploration of the information space. The context of exploratory search has been described as activities that move beyond basic lookup retrieval. Such activities rely on learning and investigation. Exploratory search activities have no predetermined goals and are described as open-ended. Therefore, the absence of clear user intents leads to difficulties in formulating queries.

The user's understanding of information needs and the information available in the data collection can evolve during an exploratory search session. Search systems tailored for well-defined narrow search tasks may be suboptimal for exploratory search where the user can sequentially refine the expressions of her information needs and explore alternative search directions. A major challenge for exploratory search systems design is how to support such behavior and expose the user to relevant yet novel information that can be difficult to discover by using conventional query formulation techniques.

Exploratory search activities confront users with problems in formulating queries and identifying directions for information exploration. Studies show that searchers tend to perform more than one task simultaneously: approximately 75% of submitted queries involve a multitasking activity. Users engage in multitask search with and without parallel browsing, but parallel browsing is a common activity and more prevalent than linear browsing. In parallel browsing, also called branching, users visit web pages in multiple concurrent threads, for example, by opening multiple tabs or windows in web browsers. Branching in browsing has been studied extensively, but little has been done to support nonlinear and parallel browsing. Recent visual search user interfaces have shown the effectiveness of interacting visually with query elements, however, there are no solutions to support fluid branching and parallel search.

Exploratory search presents further challenges to the user in expressing search intents as the current search interfaces require investigating result listings to identify search directions, iterative typing, and reformulating queries.

Surface computing is one technology that can be used in information retrieval activities. Devices with touch interaction capabilities make enable direct manipulation interactions, facilitate awareness of information available for the user beyond conventional search engine result pages, and afford visualization and spatial organization of content. However, conventional search user interfaces rely exclusively on typed-query interaction and result presentation as ranked list of documents, and thus they present challenges when transferred to touch devices.

Classical search interfaces are yet poorly suited for touch enabled devices due to their poor substitutes for keyboard and mouse inputs. Virtual keyboards are less performing than their physical counterpart and often lack usual text editing shortcuts (e.g., copy, cut, paste, cancel). As for mouse-based interactions, touch-based substitutes constrain natural touch interactions and prove difficult for quick and accurate text selection. Also, poor or lacking window management on touch devices typically allows the visualization of a single query at a time, which hinders comparison and revisiting previously retrieved information.

Moreover, the state of the art solutions model search systems for small or large surface and there is a lack of investigation on multi-touch interfaces for medium-sized display screens, such as tablets. They present different affordances if compared to smaller or larger form factor, and therefore need a different design approach. For instance, they do not support collaborative tasks as large surfaces do, given the limited screen size, but the display dimension is still bigger than mobile phones. Still such medium-sized display screens support mobility and richer visualizations, arrangements of interface elements and touch-based manipulations (e.g., two-handed gestures) than smaller mobile phones.

It is an object of the invention to avoid or mitigate aforementioned disadvantages of the prior art or to at least provide new technical alternatives.

### SUMMARY

We present a touch-based search user interface referred herein as an Exploration Wall. The Exploration Wall is designed to enable incremental exploration and sense-making of large information spaces by combining entity search, flexible use of result entities as query parameters, and spatial configuration of search streams that are visualized for interaction. Entities can be flexibly reused to modify and create new search streams, and manipulated to inspect their relationships with other entities. Data comprising of task-based experiments comparing Exploration Wall with conventional search user interface indicate that Exploration Wall achieves significantly improved recall for exploratory search tasks while preserving precision.

The Exploration Wall is based on the following design principles targeting above-mentioned challenges:

1. Flexible reuse and combination of items to facilitate query formulation.
2. Result sets of not only documents but most relevant entities to foster iterative query reformulation.
3. Use of spatial configuration of multiple search streams to identify search directions and learn about the information space.

Our design was found to facilitate exploratory search behavior when compared to the conventional baseline search user interface, as indicated by measured system effectiveness. Moreover, users were found to be more engaged with the task and subjectively more satisfied by their exploratory search. Our findings suggest that our principles can be effective when designing search user interfaces for touch devices, and can overcome many limitations of the direct adaptation of conventional search user interfaces to surfaces.

According to a first aspect of the disclosed embodiments there is provided a method comprising:

running a first explorative search in a first branch;

causing a user interface to present to a user a first group of entities relating to the first explorative search;

running a second explorative search in a second branch in parallel with the first branch;

causing the user interface to present to the user a second group of entities relating to the second explorative search simultaneously with the presenting of the first group of entities;

causing the user interface to allow the user to import one or more entities of either one of the first and second explorative searches to the remaining one of the first and second explorative searches and automatically updating said remaining explorative search.

The method may further comprise causing the user interface to present the first and second groups as parallel search streams. The parallel search streams may be presented separated in one or both of horizontal and vertical directions. The search streams may have practically unlimited length freely scrollable by the user, such as hundreds.

The user may be allowed to scroll displayed content. The user may be allowed to zoom in and out the displayed content. The user may be allowed to individually magnify one or more search streams. The user may be allowed to scroll content by swiping a touch screen with one or more fingers. Swiping with more than one fingers may result in accelerated scrolling. The scrolling perpendicularly to a general direction of a search stream may scroll all displayed search streams. The user may be allowed to scroll an individual search stream. The individual search stream may be scrolled by swiping one or more fingers in the general direction of the search stream. The use of more than one fingers may result in accelerating the scrolling.

The user may be allowed to move a display location of one search stream over or under another search stream to change a layout of search streams on a display. The user may be allowed to move the presentation of two search streams closer to each other or farther away from each other. By changing the layout of the search streams, the user may easier form new queries or change existing queries by shortening distance between locations of presented entities and a target area to which the user may wish to drag said entities.

Each of the first and second groups may comprise a query part comprising query entities and a results part comprising result entities.

The method may further comprise causing the user interface to allow the user to initiate a new explorative search with one or more entities of any one of the parallel explorative searches a new explorative search. The user interface may be caused to allow the user to initiate a new explorative search with one or more entities of any one of the parallel explorative searches a new explorative search by dragging.

According to a second aspect of the disclosed embodiments there is provided a method comprising maintaining linking between contextually connected entities of different groups of entities. The user interface may be caused to detect if the user accesses any of the entities presented to the user. Contextually connected entities that are presented at the same time with the entity accessed by the user may be identified. The user interface may be caused to indicate the identified contextually connected entities to the user. The linking may be determined by contextual correspondence.

The method may comprise presenting to a user a first group of entities relating to a first explorative search. A second group of entities relating to a second explorative search may be presented to the user. The second group of entities may be presented simultaneously with the presenting of the first group of entities. The user may be allowed to import one or more entities of either one of the first and second explorative searches to the remaining one. Updating said remaining one of the first and second explorative searches may be performed automatically in response to the importing of the one or more entities. Alternatively, the updating may be performed on request of the user.

The first and second groups may be presented as parallel search streams. Each of the first and second groups comprise a query part may comprise query entities and a results part comprising result entities. The user may be allowed to initiate a new explorative search with one or more entities of any one of the parallel explorative searches a new explorative search. The user may be allowed to initiate a new explorative search with one or more entities of any one of the parallel explorative searches a new explorative search by dragging.

The method may comprise detecting if the user accesses any of the entities presented to the user. Contextually connected entities that are presented at the same time with the entity accessed by the user may be indicated to the user.

According to a third aspect of the disclosed embodiments there is provided an apparatus comprising:

a memory comprising operating instructions; and

a processor configured to execute the operating instructions and cause accordingly the apparatus to perform the method of the first or second aspect.

According to a fourth aspect of the disclosed embodiments there is provided an apparatus comprising:

means for running a first explorative search in a first branch;

means for causing a user interface to present to a user a first group of entities relating to the first explorative search;

means for running a second explorative search in a second branch in parallel with the first branch;

means for causing the user interface to present to the user a second group of entities relating to the second explorative search simultaneously with the presenting of the first group of entities; and

means for causing the user interface to allow the user to import one or more entities of either one of the first and second explorative searches to the remaining one of the first and second explorative searches and updating said remaining explorative search.

According to a fifth aspect of the disclosed embodiments there is provided a computer program comprising computer executable program code which when executed by at least one processor causes an apparatus to perform the method of any aspect of the invention.

According to a sixth aspect of the disclosed embodiments there is provided a computer program product comprising a non-transitory computer readable medium having the computer program of the fourth aspect stored thereon.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding aspects and embodiments of the present invention have been illustrated in the foregoing. The embodiments in the foregoing are used merely to explain selected aspects or steps that may be utilized in implementations of the present invention. Some embodiments may be presented only with reference to certain aspects of the invention. It should be appreciated that corresponding embodiments may apply to other aspects as well.

### BRIEF DESCRIPTION OF THE DRAWINGS

Some embodiments of the present disclosure will be described with reference to the accompanying drawings, in which:

FIG. 1 shows a schematic diagram of a system according to an embodiment of the present disclosure;

FIG. 2 shows a block diagram of user equipment according to an embodiment of the present disclosure;

FIG. 3 shows a block diagram of a server according to an embodiment of the present disclosure;

FIG. 4 shows a screenshot that illustrates an Exploration Wall of an embodiment, when in a full-screen mode;

FIG. 5 shows a screenshot of a baseline search user interface; and

FIG. 6 shows a query-level effectiveness for long tasks and short tasks split by participants.

### DETAILED DESCRIPTION

In the following description, like reference signs denote like elements or steps.

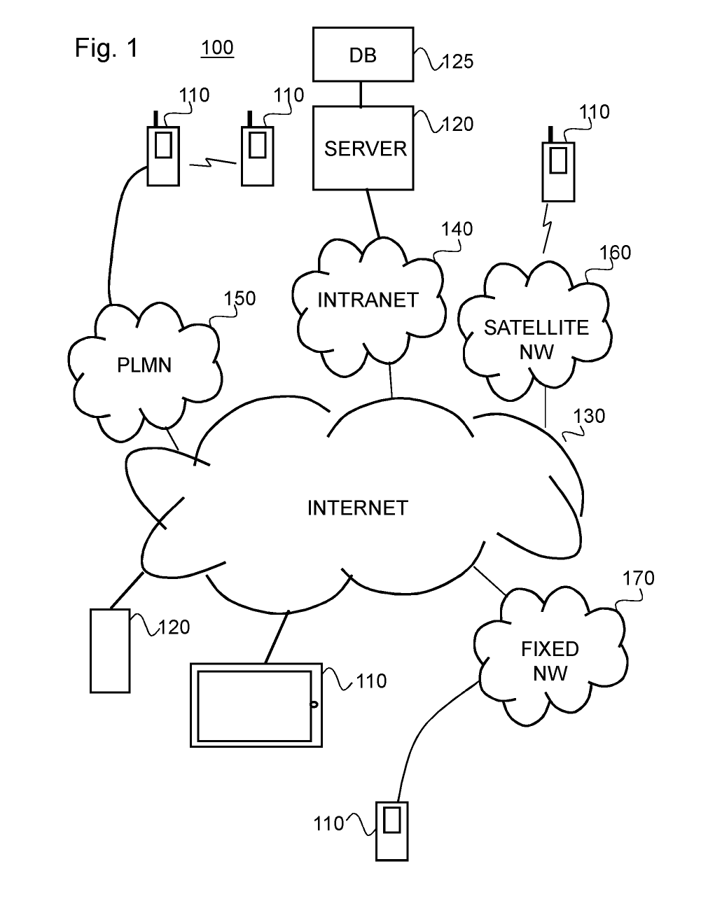

An embodiment of the present disclosure and its potential advantages are understood by referring to FIGS. 1 to 6. In the following, like reference signs denote like elements.

FIG. 1 shows a schematic picture of a system 100 according to an embodiment of the invention. The system comprises a plurality of communication channels that are permanently or on demand formed between different entities e.g. through different networks such as packet data networks. FIG. 1 illustrates the Internet 130, a public land mobile network 150, an intranet 140 (e.g. of an enterprise or corporation), a satellite network 160 and a fixed network 170 that are in sake of simplicity connected only via the Internet 130 although it should be understood that any connections between any of the drawn networks are possible. It is also appropriate to remind in this early stage that not all the networks or other elements in FIG. 1 or any other Fig. of the present drawing need to be present in all embodiments and that the drawing is merely illustrational: for example, one element may exemplify a group of many units and unitarily drawn element may be implemented using two or more discrete units or parts.

The communication between different parts of system 100 can be based on packet switched communications such as the asynchronous transfer mode (ATM) or internet protocol (IP) communications. The routing of data packets can be arranged using routers, switches and suitable cabling to pass data traffic between different mutually communicating entities. Also firewalls can be employed, possibly with stateful or stateless network access translating (NAT). Data sessions may be maintained by various network elements for duration depending on the length of time that communications are needed e.g. for conducting searching of information. The system 100 may be designed and constructed such that its capacity suffices for the sessions required for fluent operation under designed use.

FIG. 1 presents, for simplifying explanation of some embodiments, different kinds of user equipment 110, a server 120, and a database 125 accessible to the server 120. The user equipment 110 can be formed e.g. of a smart phone, personal computer, tablet computer, navigation device, game console or another communication enabled computer programmable device with computer program or firmware adaptation to support at least one embodiment of the present document. The server 120 is formed e.g. of a personal computer, server computer, virtual computer, or a cluster of computers forming a functional server machine, and of suitable software or firmware logic control to enable the server 120 to support at least one embodiment of the present document.

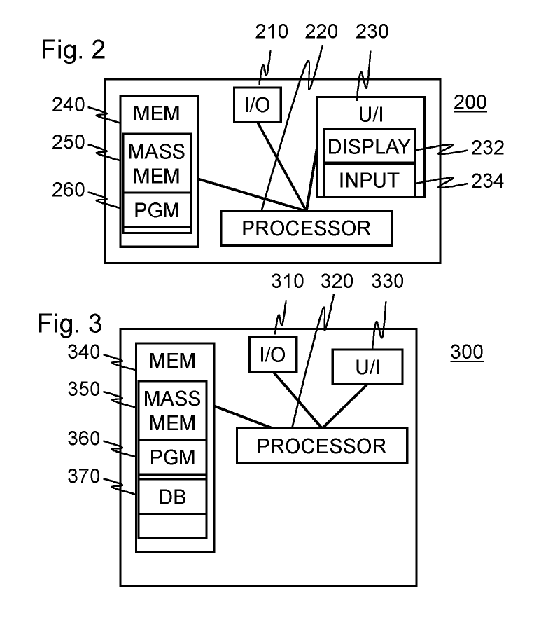

FIG. 2 shows a block diagram of user equipment 200 according to an embodiment. The user equipment comprises an input/output 210, a processor 220, a user interface 230, a memory 240 that comprises a mass memory 250 that comprises software 260 such as an operating system, computer programs, program libraries, and/or interpretable code.

The input/output 210 comprises e.g. a communication interface for input and output of information, such as a local area network, universal serial bus, WLAN, Bluetooth, GSM/GPRS, CDMA, WCDMA, or LTE (Long Term Evolution) radio circuitry. The input/output 210 can be integrated into the apparatus user equipment 200 or into an adapter, card or the like that may be inserted into a suitable slot or port of the user equipment 200. The input/output 210 can support one wired and/or wireless technology or a plurality of such technologies.

The processor 220 may be, e.g., a central processing unit (CPU), a microprocessor, a digital signal processor (DSP), a graphics processing unit, an application specific integrated circuit (ASIC), a field programmable gate array, a microcontroller or a combination of such elements. FIG. 2 shows one processor 220, but the user equipment 200 may comprise a plurality of processors.

The user interface 230 comprises a display device 232 such as a liquid crystal display, an organic light emitting diode (OLED) display, an active-matrix organic light-emitting diode, a cathode ray display, a projector display, a digital light processing projector, and/or an electric ink display. The user interface 230 further comprises an input device 234 such as a touchpad, touch screen, computer mouse, eye tracking device, keyboard, keypad, and/or an auditive control device such as a speech recognition device for receiving voice commands or a sound detection device for recognizing commands given e.g. by clapping hands. The user interface 230 may further and/or alternatively to some parts listed in the foregoing an audio transducer configured to produce audible sounds, signals and/or synthesized and/or recorded voice. The touch screen may cover the display device so that the display is usable as a touch sensing enabled display or simply referred to as a touch screen.

The memory 240 may comprise a non-volatile memory 250 or mass memory, such as a read-only memory (ROM), a programmable read-only memory (PROM), erasable programmable read-only memory (EPROM), a flash memory, a data disk, an optical storage, a magnetic storage, a smart card, or the like, and a volatile or work memory such as a random-access memory (RAM) (not shown) for enabling quick execution of program code 260 by the processor 220. The memory 240 may be constructed as a part of the user equipment 200 or it may be inserted into a slot, port, or the like of the user equipment 200 by a user.

A skilled person appreciates that in addition to the elements shown in FIG. 2, the user equipment 200 may comprise other elements, such as microphones, further presentation devices such as displays and printers, as well as additional circuitry such as further input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the user equipment 200 may comprise a disposable or rechargeable battery (not shown) for powering the user equipment 200 when external power if external power supply is not available.

In an embodiment, the user equipment is formed using hardwired logics in which case at least some of the program code may be omitted.

In an embodiment, the user equipment 200 is a tablet computer. In another embodiment, the user equipment is a fixed display screen for use in private or public premises, for example.

FIG. 3 shows a block diagram of a server according to an embodiment. The server comprises an input/output 310, a processor 320, a user interface 330, a memory 340 that comprises a mass memory 350 that comprises software 360 such as an operating system, computer programs, program libraries, and/or interpretable code. The server is also drawn to comprise a database 370 and even so that the database is contained in the mass memory 350, although the database can alternatively or additionally be comprised by another mass memory within the server or separate from the server 300 and with a suitable fast access such as a gigabit Ethernet, optical fiber connection, SCSI or PCI connection or data bus.

The input/output 310 comprises e.g. a communication interface for input and output of information, such as a local area network, universal serial bus, WLAN, Bluetooth, GSM/GPRS, CDMA, WCDMA, or LTE (Long Term Evolution) radio circuitry. The input/output 310 can be integrated into the apparatus server 300 or into an adapter, card or the like that may be inserted into a suitable slot or port of the server 300. The input/output 310 can support one wired and/or wireless technology or a plurality of such technologies.

The processor 320 may be, e.g., a central processing unit (CPU), a microprocessor, a digital signal processor (DSP), a graphics processing unit, an application specific integrated circuit (ASIC), a field programmable gate array, a microcontroller or a combination of such elements. FIG. 3 shows one processor 320, but the server 300 may comprise a plurality of processors.

The user interface 330 comprises a display device such as a liquid crystal display, an organic light emitting diode (OLED) display, an active-matrix organic light-emitting diode, a cathode ray display, a projector display, a digital light processing projector, and/or an electric ink display. The user interface 330 further comprises an input device such as a touchpad, touch screen, computer mouse, eye tracking device, keyboard, keypad, and/or an auditive control device such as a speech recognition device for receiving voice commands or a sound detection device for recognizing commands given e.g. by clapping hands. The user interface 330 may further and/or alternatively to some parts listed in the foregoing an audio transducer configured to produce audible sounds, signals and/or synthesized and/or recorded voice.

The memory 340 may comprise a non-volatile memory 350 or mass memory, such as a read-only memory (ROM), a programmable read-only memory (PROM), erasable programmable read-only memory (EPROM), a flash memory, a data disk, an optical storage, a magnetic storage, a smart card, or the like, and a volatile or work memory such as a random-access memory (RAM) (not shown) for enabling quick execution of program code 360 by the processor 320. The memory 340 may be constructed as a part of the server 300 or it may be inserted into a slot, port, or the like of the server 300 by a user.

A skilled person appreciates that in addition to the elements shown in FIG. 3, the server 300 may comprise other elements, such as microphones, further presentation devices such as displays and printers, as well as additional circuitry such as further input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the server 300 may comprise a disposable or rechargeable battery (not shown) for powering the server 300 when external power if external power supply is not available.

In an embodiment, the server is formed using hardwired logics in which case at least some of the program code may be omitted.

In an embodiment, the user equipment 200 is configured to display content under direct control of the server 300. A local script or application such as JavaScript™, ActiveX™ control or Java™ program can be used to implement user interactions such as recognizing the use of given controls such as buttons and dragging of items or scrolling content. The information for presenting by the user equipment can be obtained by and provided by the server 300. An ordinary Internet browser may thus be adapted to implement some embodiments of the present invention. Moreover, dedicated plugins or applications may be distributed, for example, through application stores such as those for Apple™ devices or Android™ devices.

The user equipment 200 may also be configured to, in course of use, send indications of user acts to the server 300 and to receive further information for presenting to the user. In one extreme, the user equipment 200 can be a dumb terminal. On the other hand, the user equipment 200 and the server 300 may be combined to a common entity for use, for example, in premises where connections are not available or their use is not possible or feasible. In such a case, the combined apparatus can be configured to operate the user interface and to perform searching using any suitable techniques. In sake of simplicity, in the following the operation visible to the user is described as front end operation by describing what appears to happen on the user equipment as operations on a terminal and operations occurring in the back end as server operations regardless whether a separate or same computing apparatus implements these operations.

Having dealt with various structures usable for implementing some embodiments of the invention, the operations of various embodiments are next discussed.

Two major aspects will be addressed in particular. A first major aspect concerns smart parallel search streams use in separate and inter-acting search processes. A second major aspect concerns the user interfacing of the smart parallel search streams. The second major aspect is enabled and necessitated by the first one so that they form a single inter-connected technical concept that is designed to offer particular technical effects.

Exploration Wall

Here we describe the interactions and implementation of the system based on the above mentioned design principles.

The User Interface

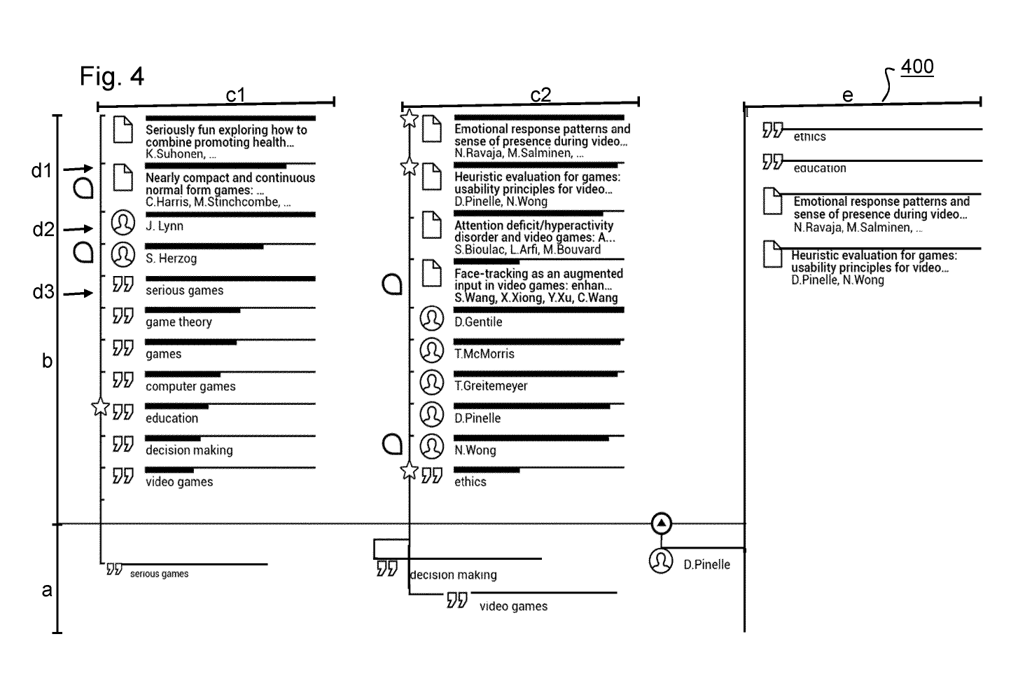

FIG. 4 shows a screenshot that illustrates the Exploration Wall 400 of an embodiment, when in a full-screen mode. The Exploration Wall is here entirely dedicated to its main workspace, which is divided in two areas: the query area at the bottom indicated with reference sign a and the result area b on top of the query area. The workspace supports information in the form of parallel search streams c1 and c2 organized by taking advantage of the multi-touch ability: the workspace can be scrolled on the horizontal axis with a simple swipe gesture on the background, horizontal space can be added or removed at will from a specific location using a conventional pinch gesture, the same pinch gesture can also be used to dilate or contract space (for example, to quickly improve legibility of an area cramped with information). When multiple fingers are used for swiping to scroll content, the content can be significantly accelerated, e.g. by a factor of 2, 5, 10 or 100 in comparison to the use of single finger.

In current instantiation, entities are of three types as drawn in FIG. 4: Documents d1, Authors d2 and Keywords d3. Each entity is represented by a pictogram, a label and a relevance gauge. Each stream may be individually or commonly divided into these different types: for example, in one or more streams, the space allocated for one entity type (e.g. authors) can be reduced down to zero or increased up to the entire space assigned to the results area of the stream in question. One can move an entity by dragging its pictogram. Additional interactions include: tap on the title of a document to reveal additional information like metadata (e.g. source, authors, publication type, publication date) and/or content, tap on the icon to store the entity. Stored entities appear highlighted and can be found in the storage drawer described below.

The storage drawer e offers an unobtrusive solution that acts as a reading list as well as an always accessible storage area for information transit. One opens and closes it by performing a swipe gesture from the right edge of the display.

In the query area a, a first query (in this case “mobile phone”) returns a search stream composed of news articles most relevant to the query, as well as a set of most relevant keywords extracted from a larger set of related articles as shown in the results area b. The user can modify the weight of the keywords by sliding them vertically, after which the stream will refresh, updating articles and keywords accordingly. If dropped outside their initial stream, keywords can either trigger a new search stream or be passed to an already existing parallel stream.

The Search Engine

The search engine was designed to support multi-touch interaction design of Exploration Wall and is based on two design rationale. First, the entity ranking where entities that are returned for the user to manipulate and use to formulate queries should be as central to the topic as possible. For example, if the user searches for “information retrieval”, she is not expecting back only entities that occur in the top ranked documents, but that are central for the field of information retrieval. Second, the document ranking where the documents that are returned for the user as results after making some query, say “information retrieval” and “relevance feedback” should be not the most central entities, but the most relevant documents matching the query.

Entity Ranking

We represent the data as an undirected graph, where each document, keyword, and author are represented as vertices and the edges represent their occurrence in the document data. The centrality ranking is based on the user's relevance feedback on vertices determined by dragging them into the query area. Each cluster in a query area represents a separate query that consists of a set of vertices. We use a PageRank method to compute the ranking of the vertices. The set of nodes that the user has chosen to be part of an individual query form the personalization vector that is set to be the prior for the PageRank computation. We compute the steady distribution by using the power iteration method with 50 iterations. The top k=10 nodes from each entity category (keyword, author) are selected for presentation for the user.

Document Ranking

The document ranking is based on language modelling approach of information retrieval, where a unigram language model is built for each document and the maximum likelihood of the document generating the query is used to compute the ranking. We use Jelinek-Mercer smoothing to avoid zero probabilities in the estimation. Intuitively, separating the entity ranking and document ranking approaches makes it possible to compute a limited set of entities that are likely to be the most important in the graph given the user interactions and allows users to target their feedback on a subset of the most central nodes given the interaction history of the user in any subsequent iteration. At the same time, the document ranking enables accurate and well-established methodology for ensuring relevance of the documents.

Evaluation

The main purpose of the evaluation was to observe the effects and implications of the design of Exploration Wall on search performance and search behavior. Therefore, Exploration Wall was compared to a conventional search interface which was used as a baseline. The experiment concerned the following factors: effectiveness, user performance, search behavior, usability and user engagement. The evaluation was composed of two tasks, a short one (5 minutes) and a long one (20 minutes).

Dataset

We decided to limit the data to scientific literature for two reasons. First, the data should allow retrieval tasks that result in exploration, and scientific search tasks are suitable for scenarios where users' goals are uncertain and require exploratory search behavior. Second, experts were available for providing high quality relevance assessments for task outcomes.

We used a document set including over 50 million scientific documents from the following data sources: the Web of Science prepared by Thomson Reuters, Inc., the Digital Library of the Association of Computing Machinery (ACM), the Digital Library of Institute of Electrical and Electronics Engineers (IEEE), and the Digital Library of Springer. The information about each document consists of: title, abstract, author names, and publication venue. Both the baseline and Exploration Wall used the same document set.

Baseline

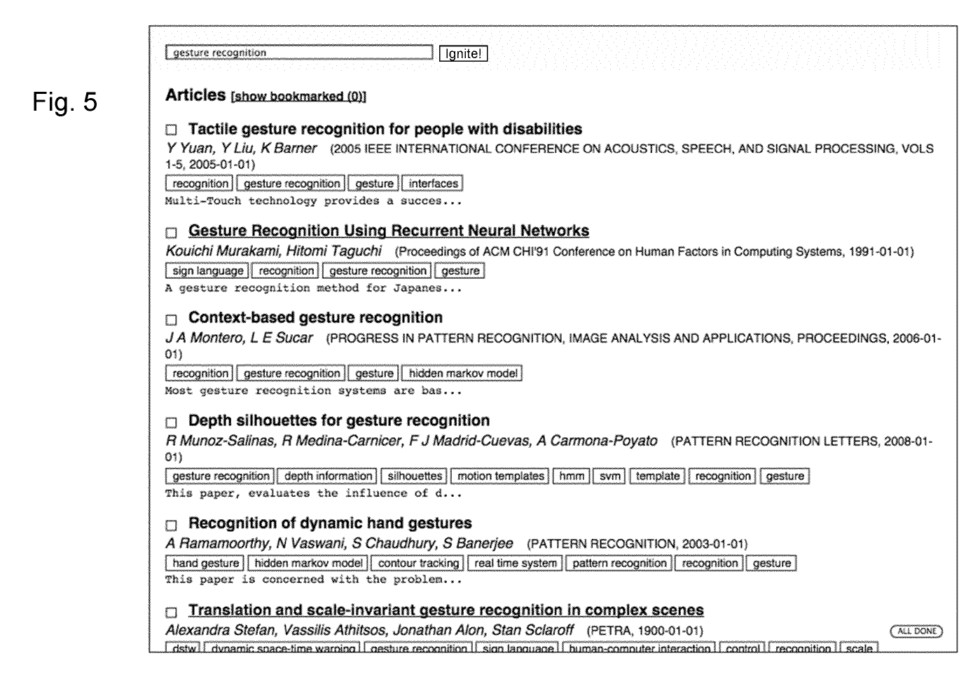

The baseline, shown on FIG. 5, was implemented following the interface principles of traditional search tools: typed query and resulting list of returned documents presented by title, with authors and keywords. The system uses the same data set used by Exploration Wall to permit comparability. Also, the ranking is based on the same document retrieval model as in Exploration Wall, but to mimic traditional search engines it ranks only documents, while authors and keywords are only shown as additional information associated to each document. Last, our system did not allow dynamic updates of the search result when typing the query. All these factors aimed to create a baseline allowing us to focus the evaluation solely on the user interface design of Exploration Wall and its implications.

Tasks

The evaluation was composed of two tasks, a short one and a long one. We chose 6 possible different topics for the two tasks: crowdsourcing, smartphones energy efficiency, diagrams, semantic web, lie detection and digital audio effects. In order to ensure that participants were not experts in the topics and could perform a real exploratory search, they pre-rated their familiarity with the topics on a 1 (less familiar) to 5 (most familiar) scale. The four less familiar topics were used in the tasks. Both tasks were performed with different topics, so the participants did not the know the results from the previous task.

Short Task

For this task, we asked the users: “Search and list 5 relevant authors, documents and keywords that you consider relevant in topic Y.” The time limit for this task was 5 minutes.

Long Task

For this task, we asked the users: “Imagine that you are writing a scientific essay on the topic X. Search and collect as many relevant scientific documents as possible that you find useful for this essay. During the task, please, list what you think are the top five key technologies, persons, documents and research areas and write five bullet lines, which would work as the core content of the essay.” The time limit for this task was 20 minutes.

Participants and Procedure

We recruited 10 researchers from the computer science departments of two universities with a range of research experience. The 20% of them were females, which matched the gender ratio of both departments, and the mean age was M=30.5, SD=5.52. In the experiment, the participants used an iPad Air Wi-Fi tablet.

In this study, we followed a within-subjects experiment design, counterbalanced by changing the order of the two tested interfaces, as well as the order of the two tasks. Before starting the main tasks, users received detailed instructions on how to use the interface and performed a 5 minutes training task on each interface. For text entry, we relied on the native virtual keyboard of the tablet. At the end of the sessions participants were asked to answer the UES and SUS questionnaires for each interface via on-line forms (Google Forms). We used the API and service of logentries.com to log all actions and data.

Measures

The experiment considered the following factors: effectiveness, user performance, search behavior, usability and user engagement which were measured as follows.

Effectiveness

The effectiveness refers to the quality of the information retrieved and displayed by a system. Since our baseline system returns lists of documents while Exploration Wall returns lists of mixed-type entities, we chose to solely measure the quality of the displayed documents. We created ground truth by pooling the retrieved documents from the system logs. Domain experts were then asked to assess the relevance of the retrieved documents on a binary scale (relevant or irrelevant). Effectiveness was measured by precision, recall and F-measure at two levels. First, we measured the average retrieval effectiveness at a query level as an average quality of the documents returned in response to a user interaction. Second, we measured the retrieval effectiveness at task level as a cumulative quality of documents retrieved within the whole search session.

User Performance

The user performance was evaluated based on expert ratings of the task outcome. For the short task, the outcome was a list of documents, and two types of entities: authors and keywords. The relevance of each item was evaluated on a 5-point scale (1 less relevant-5 most relevant). The outcome of the long task was an essay, a set of documents, and a set of entities: keywords representing technologies and research areas, and persons. The sets of documents and entities were evaluated in the same way as in the short task, while the essay was evaluated on a different 5-point scale (5=Excellent, 4=Good, 3=Satisfactory, 2=Deficient, 1=Failing).

Search Trail Analysis

In order to understand and compare users' search behavior, we logged user actions and extracted corresponding search trails using a method as presented in White, R. W., and Drucker, S. M. Investigating behavioral variability in web search. In Proceedings of the 16th international conference on World Wide Web, ACM (2007), 21-30. In a similar manner, we then looked for descriptive statistics of the search trails by selecting six parameters relevant to both interfaces.
Number of queries: the total number of queries that were submitted during each task on both interface.
Number of text entries per query
Number of revisits: The number of revisits to a query or stream consulted earlier in the current trail.
Number of branches: The number of times a subject revisited a query or stream on the current trail and then proceeded with formulation of a new query.
Number of queries/min: the number of queries per minute that were submitted during each task on both interface.
Number of parallel queries: Number of parallel streams produced with Exploration Wall or number of tabs opened with the baseline.

### Usability and Engagement

As usability assessment questionnaires we used the standard System Usability Scale (SUS) and the User Engagement Scale (UES) for exploratory search. SUS consists of a ten item questionnaire and is a widely used and validated for measuring perceptions of usability. Since the degree of user engagement is a strong indicator of exploratory search performance, we chose to use UES for exploratory search. The User Engagement Scale (UES) questionnaire include 27 questions considering six different dimensions: Aesthetics (AE), Focused Attention (FA), Felt Involvement (FI), Perceived Usability (PUs), Novelty (NO) and Endurability (EN) aspects of the experience.

Results

In this section, we present results from the user experiments divided according to the different factors: effectiveness, user performance, search trail analysis, and usability and engagement.

TABLE 1
Results of the search trail analysis for the short and long tasks.
Mean, Standard Deviation, Median (used in the Wilcoxon Matched-Pairs test) as
well as Significant differences of search trail feature considering both interfaces.

| | BL | | | EW | | | BL vs EW |
|---|---|---|---|---|---|---|---|
| Search Trail features | M | SD | Median | M | SD | Median | Wilcoxon Test |
| | Long Task | | | | | | |
| No. of queries | 4.30 | 3.09 | 4.50 | 12.10 | 6.97 | 13.50 | Z = −2.76, p < 0.01 |
| No. of text entries/query | 1.00 | 0.00 | 1.00 | 0.36 | 0.35 | 0.27 | Z = 2.76, p < 0.01 |
| No. of branches | 0.10 | 0.31 | 0.00 | 5.70 | 4.55 | 6.00 | Z = −2.68, p < 0.01 |
| No. of revisits | 0.70 | 1.64 | 0.00 | 7.00 | 6.09 | 6.00 | Z = −2.67, p < 0.01 |
| No. of queries/min | 0.26 | 0.17 | 0.26 | 0.63 | 0.36 | 0.70 | Z = −2.70, p < 0.01 |
| No. parallel queries | 1.70 | 1.06 | 1.00 | 8.50 | 5.89 | 7.00 | Z = −2.76, p < 0.01 |
| | Short Task | | | | | | |
| No. of queries | 2.50 | 1.58 | 2.00 | 3.50 | 2.12 | 4.00 | Z = −1.46, p > 0.05 |
| No. of text entries/query | 1.00 | 0.00 | 1.00 | 0.55 | 0.35 | 0.47 | Z = 2.55, p < 0.05 |
| No. of branches | 0.00 | 0.00 | 0.00 | 0.8 | 1.03 | 0.5 | Z = −2.21, p < 0.05 |
| No. of revisits | 0.20 | 0.42 | 0.00 | 1.1 | 1.10 | 1.0 | Z = −1.81, p > 0.05 |
| No. of queries/min | 0.59 | 0.33 | 0.45 | 0.86 | 0.36 | 0.93 | Z = −2.24, p > 0.05 |
| No. of parallel queries | 1.30 | 0.67 | 1.00 | 2.70 | 2.00 | 2.00 | Z = −2.40, p < 0.05 |

The values in bold show the significant differences.
BL = baseline,
EW = Exploration Wall.

Effectiveness

The effectiveness results are given in Table 2. The results show that Exploration Wall shows substantial improvement in the long task. The improvement was found to hold for task-level measurement, but also for averaged interaction-level measurement for which the recall and the F-measure were found to be significantly higher compared to the baseline. On average at the query level, the F-measure for the Exploration Wall was improved (M=0.136, SD=0.122). This improvement was statistically significant, t(9)=3.519, p<0.01. This is a direct consequence of the improvement in the recall (M=0.142, SD=0.094, t(9)=4.790, p<0.001). The difference in precision was not significant (M=0.005, SD=0.366) which indicates that while Exploration Wall improves recall it retains precision. In terms of effectiveness, no statistically significant differences between the systems were found in the short task.

TABLE 2
Effectiveness results for the short and long tasks. Results are
reported cumulatively for the whole duration of the task and as a
mean of every query-response during the task. Exploration Wall
significantly outperforms the baseline system in recall and F-measure
in the long task without sacrificing precision. No significant
differences between the systems were found in the short task.

| | Long Task | | | Short Task | | |
|---|---|---|---|---|---|---|
| | BL | EW | p | BL | EW | p |
| P (Task) | 0.40 | 0.42 | 0.85 | 0.52 | 0.58 | 0.67 |
| R (Task) | 0.13 | 0.38 | <0.01 | 0.18 | 0.21 | 0.59 |
| F (Task) | 0.17 | 0.34 | <0.01 | 0.25 | 0.26 | 0.90 |
| P (Query) | 0.53 | 0.53 | 0.96 | 0.52 | 0.69 | 0.16 |
| R (Query) | 0.11 | 0.25 | <0.01 | 0.15 | 0.16 | 0.69 |
| F (Query) | 0.17 | 0.31 | <0.01 | 0.22 | 0.24 | 0.41 |

The values in bold show the significant differences.
P = Precision,
R = Recall,
F = F1 measure,
EW = Exploration Wall,
BL = Baseline.

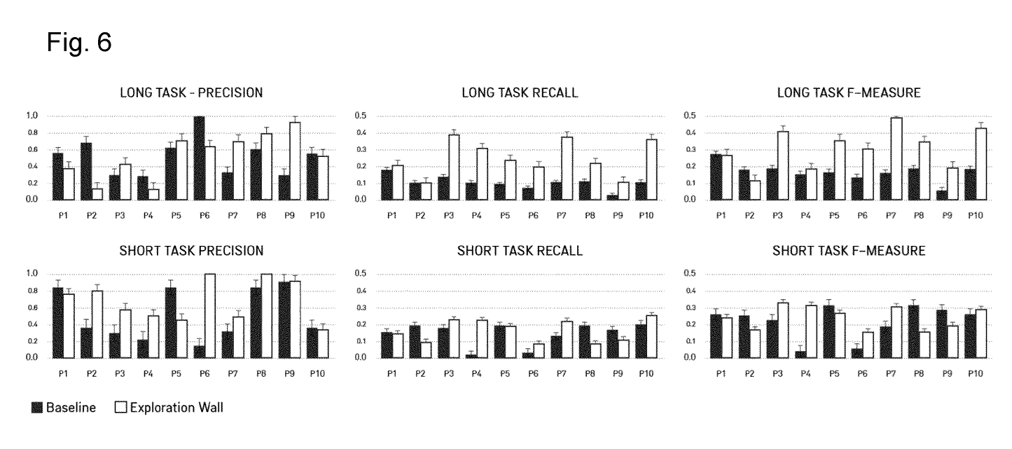

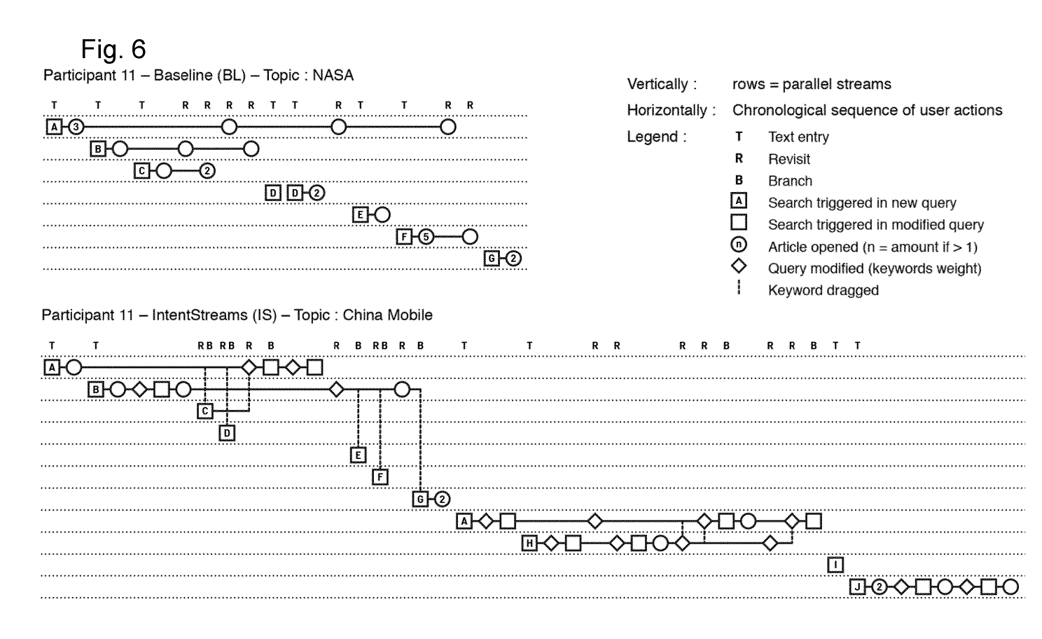

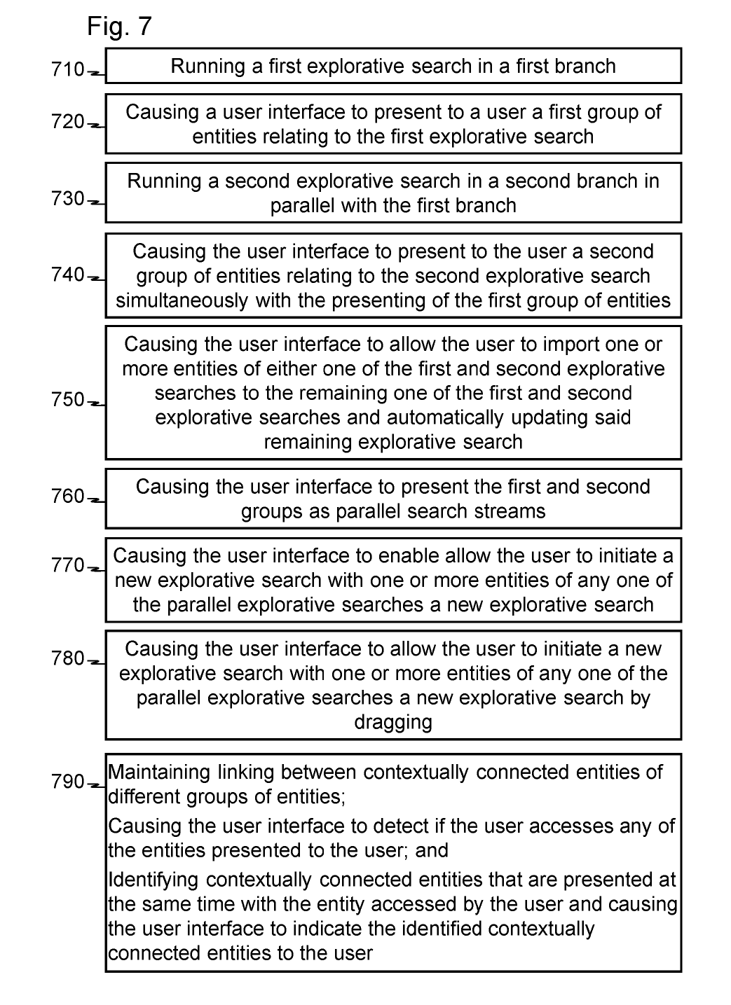

FIG. 6 shows the query-level effectiveness for the long tasks and the short task split by participants. Exploration Wall constantly outperforms the baseline system in terms of recall and F-measure in the long task. The effect is steady across participants. No significant differences between the systems were found in the short task.

User Performance

Unlike the effectiveness, the user performance showed no significant differences Exploration Wall and the Baseline. Regarding the relevance selected items, the mean values for the long task were M=3.54; SD=0.67 for Exploration Wall and M=3.45; SD=0.82 for Baseline, while for short task they were M=3.60; SD=1.23 for Exploration Wall and M=3.83; SD=0.99 for Baseline. Regarding the relevance of the essays produced in the end of the long task the mean values were M=3.90; SD=0.75 for Exploration Wall and M=4.05; SD=0.69 for Baseline.

Search Trail Analysis

Table 1 shows the results of the search trail analysis. The Shapiro-Wilk test indicated that the search trail data did not follow a normal distribution, and the Wilcoxon MatchedPairs test was used for significance testing. The users in the Exploration Wall condition were found to use all of the measured interaction features significantly more than the users in the baseline condition in the long task. Differences were also found in the short task. The users in the Exploration Wall condition typed less, branched more, and used more parallel queries.

Usability and Engagement

The results for the mean of answers of the SUS questionnaire, i.e., for usability, were M=78.85; SD=12.43 for Exploration Wall and M=62.25; SD=15.65 for the baseline. A paired t-test showed a significant difference (t(9)=2.36; p<0.05) between the two systems, revealing higher usability for Exploration Wall. The results of the UES questionnaires are also favorable for Exploration Wall. Wilcoxon Matched-Pairs test shows that in 70% of the questions there is a significant difference between the interfaces, all in favor of Exploration Wall.

### DISCUSSION

The study shows how Exploration Wall is an effective tool for exploratory search on touch surfaces. Participants using Exploration Wall were able to exploit parallel search streams to iteratively refine their queries and deeply explore the search tree. The difference in recall proves that more relevant documents were retrieved when using Exploration Wall.

Exploration Wall also led to a more active search behavior, with more queries per minute and more branches. In addition, if we consider the fact that participants used more parallel queries with Exploration Wall (parallel streams) than with the baseline (parallel tabs), we can conclude that the participants took advantage of parallel streams with consequent avoidance of text input.

Results from the UES questionnaire also show a better user engagement, a factor that is likely to have contributed to the more active search behavior. In addition, the SUS scale shows that Exploration Wall presents a better usability than conventional search interfaces on tablets. The study confirms how our design approach facilitates query formulation, by directing exploration in unknown areas, and providing alternatives to text inputs. While little or no differences were appreciated in short tasks, Exploration Wall proved to be an effective tool for long tasks by showing improved recall while preserving precision, as well as improved user engagement and satisfaction.

### CONCLUSION

This work has important implications for future development of exploratory search systems in particular considering multimodal interaction and user interface for entity oriented search. The principles are applicable to other data sets such as for example news search as well as other devices and sizes (e.g. large multi-touch screen for collaborative work, mobile devices for mobility and privacy, combinations of devices, desktop). Our results suggest that the design principles on which Exploration Wall is based, such as touch-based manipulation of information entities organized into parallel streams, are powerful tools to be considered when designing user interfaces supporting exploratory search.

### Technical Effects and Advantages Some Embodiments

A. Flexible reuse and combination of information items to facilitate query formulation. The need for text entry can be reduced by itemizing information into entities of different types that can be flexibly manipulated and “dragged around” to support and facilitate all fundamental tasks like selection, duplication, grouping, deletion. Entities can be used to formulate queries, either individually or combined, to get a set of new entities as search results. An existing query can then be easily refined or reformulated by addition or removal of such entities and the results would update accordingly. The more efficient the query is, the faster the user can perform it and the sooner the user equipment can be switched off and the server is freed from processing searches of the user in question.

The possibility to input text is still necessary in some situations, for example if the system fails to make the proper suggestions or for specifying an initial query. Support text input can thus be provided as an optional and preferably concealable alternative to instantiate and/or control a search session.

B. Result sets of not only documents but most relevant entities foster iterative query reformulation and reduce search time and computation cost. To foster iterative query reformulation, the notion of search streams was introduced for describing an interactive structure supporting a query and related results: the query itself is formed of one or more entities and is composed by the user, while the results are shown as a vertical arrangement of entities related to the query and positioned above it. In the query area, items can be moved freely. Under a certain criterion such as a horizontal distance threshold, those entities are considered as a single query. The unity of a query can be visualized through a network of thin lines linking the entities together. At first the query can visually lead to a button that triggers the retrieval. The search engine then returns a set of entities related to the query. Those represents not only retrieved documents but also new entities, such as keywords or persons. They are vertically ordered by type and relevance. The flexibility of the search stream comes from its two-level structure. It acts partly as a consolidated unit which can be moved around and considered as an almost traditional list of results, but each document or entity can become a new query, or part of an existing query, in the same stream or a parallel one.

C. Use of spatial configuration of multiple streams to identify search directions and learn about the information space. To facilitate steering decisions and help the user formulate queries, search is supported on simultaneous parallel streams. Persistency of search and context improves exploration by fostering trials without fear of losing current work, and supporting information comparison and entity association leading to quick instantiation of new queries or quick query reformulation. It also allows the user to keep track of former queries and results while supporting unconstrained branching and revisits in the actual search process. Moreover, thanks to the persistency, unnecessary repetition of server search operations can be avoided and thanks to the use of the spatial configuration, relatively small displays can be used so that the user can still easily handle the information and conduct efficient information search and access. This helps to counter the present trend of manufacturing ever larger terminals (mobile phones and tablets, for example) for convenient use. Moreover, the spatial configuration or layout of multiple streams next to each other provides an intuitive history of earlier searches. Furthermore, the user can work on one branch during execution of the search on other branch or branches.

Various embodiments are described in the foregoing. Next, experimental data is presented along with some further explanation of some techniques that are usable to implement some embodiments.

IntentStreams

IntentStreams is a system implemented based on the foregoing embodiments. IntentStreams supports parallel browsing and branching during search without the need to open new tabs. It presents parallel streams of searches, where each stream shows a list of resulting documents and keywords, and a display of the underlying queries as keywords representing the search intent of the stream. New streams are initiated by the user, where the search intent of a new stream is initialized by typing a traditional query or by dragging keywords available in any of the streams. In each stream, in addition to the user-chosen keywords, the system proposes other relevant keywords and orders them vertically by their predicted relevance. The users can change the relative relevance of keywords in the query intent of each stream and branch new streams by simply dragging keywords. IntentStreams was tested using 25 million news articles crawled from public news sources in a comparative study with 13 subjects. The experimental results show that IntentStreams better supports parallel search and branching behavior when compared to a conventional search system.

IntentStreams provides a unique horizontally scrollable workspace divided in two areas: the keywords area at the bottom and the results area on top, for example. By clicking (tapping touch screen) the workspace, the user gets prompted to type a first query. The system returns a list of relevant documents in the results area and a set of related keywords in the keywords area. Keywords are positioned vertically by weight and horizontally by topic proximity. The vertical arrangement is called a stream and can be easily manipulated, modified and refreshed. The content of a document can be seen by clicking the title. A click and hold on a document highlights keywords directly related to it. A click and hold on a keyword highlights related documents. By moving keywords vertically, the user can change their weight; by hitting the refresh button, the stream then updates and presents a new set of documents and keywords. New parallel streams can be created by clicking next to an existing stream and typing a new query, or simply by dragging a keyword outside of its stream. Since the workspace is horizontally scrollable, the amount of parallel streams a user can create is limited only by computer memory. The amount of parallel streams that can be shown simultaneously is determined by the display resolution. Streams can be dragged and rearranged. A button lets the user delete streams.

Interactive Intent Model

For each search stream, the interactive intent model is similar to the model in a previous non-parallel system and has two parts: a model for retrieval of documents, and a model for estimating the user's search intent (relevance of keywords to the user's information need). We describe both below. Document retrieval model. For each stream, we estimate a relevance ranking where documents are ranked by their probability given the intent model for the stream. We use a unigram language model. The intent model yields a vector \hat{v} with a weight \hat{v}ᵢ for each keyword kᵢ. The \hat{v} is treated as a sample of a desired document. Documents dⱼ are ranked by probability to observe \hat{v} as a sample from the language model M_{d}_{ⱼ} of dⱼ. Maximum likelihood estimation yields

\hat{P}(\hat{v}|M_{d}_{ⱼ})=Πᵢ₌₁^{|\hat{v}|}(\hat{P}ₘₗₑ(kᵢ|M_{d}_{ⱼ}))^{\hat{v}}^{ᵢ}. We regularize probabilities \hat{P}ₘₗₑ(kᵢ|M_{d}_{ⱼ}) in dⱼ towards overall keyword proportions in the corpus by Bayesian Dirichlet smoothing. In each stream the dⱼ are ranked by αⱼ=\hat{P}(\hat{v}|M_{d}_{ⱼ}). To expose the user to more novel documents we sample a document set from the ranking and show them in rank order. We use Dirichlet Sampling based on the αⱼ, and favor documents whose keywords got positive feedback by increasing their αⱼ.

User Intent model. For each stream, the intent model estimates relevance of keywords from feedback to keywords. For a stream launched by a typed query, we use the query with weight 1 as the initial intent model; for a stream launched by dragging a keyword we use the keyword with weight 1. The user gives feedback as relevance scores rᵢϵ[0, 1] for a subset of J keywords kᵢ, i=1, . . . , J in the stream; rᵢ=1 means kᵢ is highly relevant and the user wishes to direct the stream in that direction, and rᵢ=0 means kᵢ is of no interest.

Let kᵢ be binary n×1 vectors telling which of the n documents kᵢ appeared in; to boost documents with rare keywords we convert the kᵢ to tf-idf representation. We estimate the expected relevance rᵢ of a keyword kᵢ as [symbol] [rᵢ]=kᵢ^{T}w. The vector w is estimated from user feedback by the LinRel algorithm. In each search iteration, let k₁, . . . , kₚ be the keywords for which the user gave feedback so far, let K=[k₁, . . . , kₚ]^{T} be the matrix of their feature vectors, and let r^{feedback}=[r₁, r₂, . . . , rₚ]^{T} be their relevance scores from the user. LinRel estimates ŵ by solving r^{feedback}=Kw, and estimates relevance score for each kᵢ as r^{feedback}=Kw.

To expose the user to novel keywords, in each stream we show keywords kᵢ not with highest rᵢ, but with highest upper confidence bound for relevance, which is \hat{r}ᵢ+ασᵢ, where σᵢ is an upper bound on standard deviation of \hat{r}ᵢ, and α>0 is a constant for adjusting the confidence level. In each iteration, we compute sᵢ=K(K^{T}K+λI)⁻¹kᵢ where λ is a regularization parameter, and show the kᵢ maximizing

$${s}_{i}^{T} {r}^{feedback} + \frac{α}{2} ‖ {s}_{i} ‖$$

representing estimated search intent. We optimize horizontal positions of the shown kᵢ by dimensionality reduction; kᵢ get similar positions if their relevance estimate changes similarly with respect to a set of additional feedback.

Evaluation

We evaluated the system to find out if and how IntentStreams supports parallel browsing and branching behavior. IntentStreams was compared against a baseline system with an interface similar to a traditional Google search interface. Our hypothesis was that, compared to the baseline, IntentStreams generates (1.) more parallel streams, (2.) more revisits, and (3.) more branches. We used the following metrics: number of parallel streams, number of revisits, and number of branches. In the baseline, the number of parallel streams denotes the number of tabs opened, a revisit indicates returning to an already open tab, and a branch denotes a query updated after a revisit. In IntentStreams, a revisit occurs when a user performs certain activities (opening an article, weight change) on a previously created stream. A branch occurs when a new stream is created from an existing one. That includes both creating a new query by dragging a keyword or updating the existing stream by modifying the weights of its keywords.

Method

We evaluated the system with 13 volunteers (4 female). The participants' age ranged from 19 to 36 with mean of 28.4 (SD=4.05). Their levels of education were: 8% PhD, 46% Master, 38% Bachelor, 8% High School. Each participant received two movie tickets for their participation. We used a within-subject design, where participants were asked to perform two tasks, one with IntentStreams and one with the baseline. We counterbalanced by changing the order in which the two tasks were performed and the order in which the two systems were used.

The task was set in an essay writing scenario and formulated as follows: “You have to write an essay on recent developments of X where you have to cover as many subtopics as possible. You have 20 minutes to collect the material that will provide inspiration for your essay. You have additional 5 minutes to write your essay.” The two tasks performed by the participants covered two topics: (1.) NASA, and (2.) China Mobile.

Experiments were run in a laboratory on a laptop with OS X operating system. Each participant signed a consent form. To determine the eligibility, we asked candidates how familiar they were with each chosen topic on a 1-5 scale, where 1 means “no knowledge” and 5 means “expert knowledge”. Only those with a score lower than 3 were considered eligible. Before the experiment, participants received detailed instructions and performed a 5-minute training session.

To evaluate the system, we connected it to a news repository of English language editorial news articles crawled from publicly available news sources from September 2013 to March 2014. The database contains more than 25 million documents. The documents were originally collected for monitoring media presence of numerous interested parties, and hence the collection has wide topical coverage. All the documents were preprocessed by the Boilerpipe tool presented by Kohlschütter, C., Frankhauser, P., and Nejdl, W. Boilerplate in “Boilerplate detection using shallow text features”, 2010 and the keyphrases were extracted with the Maui toolkit presented by Medelyan, O., Frank, E., and Witten, I. H. in “Human-competitive tagging using automatic keyphrase extraction”, 2009, p. 1318-1327.

The baseline system was connected to the same news repository. In the baseline system, users could type queries and receive a list of relevant news articles. To start a new parallel query, a new tab had to be opened.

Findings

FIG. 6 shows an example of branching behavior from the case study: top—Baseline; bottom—IntentStreams.

Table 1 shows the results of the log analysis. In the 20-minute long sessions, IntentStreams on average generated 7.84 more queries (SD=7.27), 6.38 more parallel streams (SD=4.03), 4.54 more revisits (SD=4.52), and 3.62 more branches (SD=4.01). A paired t-test indicates that all those differences are statistically significant (p<0.01).

Parallel Search Supported in IntentStreams.

Results show that users created more parallel streams than opened new tabs. While the system allows the creation of parallel streams, the users revisit earlier ones consistently, which denotes parallel search behavior. In fact, revisits are higher in the IntentStreams condition.

Branching Supported in IntentStreams.

In IntentStreams, more queries and parallel streams were created through branching. FIG. 2 presents a visual representation of a participant's search behavior, showing the difference between the linear search behavior in the baseline and the more articulated search behavior in IntentStreams.

Further, IntentStreams supports more exploration. In IntentStreams, more exploration of the information space was done as can be seen from the higher number of queries.

### CONCLUSIONS

We introduced the IntentStreams system for exploratory search of news based on parallel visualization of smart search streams. It models each search stream by an intent model, allows rapid tuning by feedback to keywords, and allows rapid initiation of new streams by keyword interaction without typing. Initial experiments show that users take advantage of the rich parallel search opportunities and engage in much stronger parallel browsing and branching behavior than in a traditional system.

This is an important finding as current browsing and searching behavior is already characterized by multitask search (in the same query field users alternate tasks), parallel browsing (users browse on parallel tabs or windows), and engage in branching (a new tab or window is created from a link or result of a previous window or tab). Branching has been shown to be more important in informational browsing than navigational search. The approach proposed in IntentStreams can be incorporated into other search interfaces to provide an effective way to branch search.

TABLE 1
Comparison between IntentStreams (IS) and the baseline (BL).
The number of queries, parallel streams, revisits, and branches, for
each participant P1, . . . , P13 queries par. streams revisits branches

| | queries | | par. streams | | revisits | | branches | |
|---|---|---|---|---|---|---|---|---|
| | BL | IS | BL | IS | BL | IS | BL | IS |
| P1 | 5 | 5 | 2 | 5 | 0 | 7 | 0 | 1 |
| P2 | 5 | 4 | 1 | 2 | 1 | 0 | 1 | 0 |
| P3 | 7 | 17 | 1 | 12 | 1 | 6 | 1 | 4 |
| P4 | 9 | 11 | 1 | 6 | 0 | 2 | 0 | 2 |
| P5 | 14 | 18 | 1 | 12 | 0 | 9 | 0 | 7 |
| P6 | 1 | 8 | 1 | 5 | 0 | 0 | 0 | 0 |
| P7 | 12 | 18 | 7 | 14 | 5 | 7 | 2 | 3 |
| P8 | 22 | 26 | 3 | 12 | 6 | 15 | 1 | 8 |
| P9 | 6 | 18 | 6 | 12 | 4 | 4 | 0 | 0 |
| P10 | 8 | 11 | 7 | 11 | 6 | 5 | 0 | 0 |
| P11 | 8 | 21 | 7 | 11 | 7 | 12 | 0 | 8 |
| P12 | 16 | 35 | 11 | 14 | 3 | 14 | 1 | 9 |
| P13 | 3 | 26 | 3 | 18 | 0 | 11 | 0 | 11 |

FIG. 7 shows a flow chart illustrating various steps that can be taken in some embodiments of the invention, including:

710: running a first explorative search in a first branch;

720: causing a user interface to present to a user a first group of entities relating to the first explorative search;

730: running a second explorative search in a second branch in parallel with the first branch;

740: causing the user interface to present to the user a second group of entities relating to the second explorative search simultaneously with the presenting of the first group of entities;

750: causing the user interface to allow the user to import one or more entities of either one of the first and second explorative searches to the remaining one of the first and second explorative searches and automatically updating said remaining explorative search;

760: causing the user interface to present the first and second groups as parallel search streams;

770: causing the user interface to enable allow the user to initiate a new explorative search with one or more entities of any one of the parallel explorative searches a new explorative search;

780: causing the user interface to allow the user to initiate a new explorative search with one or more entities of any one of the parallel explorative searches a new explorative search by dragging; and

790: maintaining linking between contextually connected entities of different groups of entities; causing the user interface to detect if the user accesses any of the entities presented to the user; and identifying contextually connected entities that are presented at the same time with the entity accessed by the user and causing the user interface to indicate the identified contextually connected entities to the user.

Various embodiments have been presented. It should be appreciated that in this document, words comprise, include and contain are each used as open-ended expressions with no intended exclusivity.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed embodiments of this invention may be used to advantage without the corresponding use of other features. As such, the foregoing description shall be considered as merely illustrative of the principles of the present disclosure, and not in limitation thereof. Hence, the scope of the invention is only restricted by the appended patent claims.

1. A method comprising:
running a first explorative search in a first branch;
causing a user interface to present to a user a first group of entities relating to the first explorative search;
running a second explorative search in a second branch in parallel with the first branch;
causing the user interface to present to the user a second group of entities relating to the second explorative search simultaneously with the presenting of the first group of entities; and
causing the user interface to allow the user to import one or more entities of either one of the first and second explorative searches to the remaining one of the first and second explorative searches and updating said remaining explorative search.

2. The method of claim 1, further comprising:
causing the user interface to present the first and second groups as parallel search streams.

3. The method of claim 1, wherein each of the first and second groups comprise a query part comprising query entities and a results part comprising result entities.

4. The method of claim 1, wherein the updating of said remaining explorative search is performed automatically.

5. The method of claim 1, further comprising:
causing the user interface to allow the user to initiate a new explorative search with one or more entities of any one of the parallel explorative searches a new explorative search.

6. The method of claim 1, further comprising:
causing the user interface to allow the user to initiate a new explorative search with one or more entities of any one of the parallel explorative searches a new explorative search by dragging.

7. The method of claim 1, further comprising:
maintaining linking between contextually connected entities of different groups of entities;
causing the user interface to detect if the user accesses any of the entities presented to the user; and
identifying contextually connected entities that are presented at the same time with the entity accessed by the user and causing the user interface to indicate the identified contextually connected entities to the user.

8. A method in a user interface for performing explorative search in parallel branches, comprising:
presenting to a user a first group of entities relating to a first explorative search;
presenting to the user a second group of entities relating to a second explorative search, simultaneously with the presenting of the first group of entities; and
allowing the user to import one or more entities of either one of the first and second explorative searches to the remaining one and causing automatically updating said remaining one of the first and second explorative searches.

9. The method of claim 8, further comprising:
presenting the first and second groups as parallel search streams.

10. The method of claim 8, wherein each of the first and second groups comprise a query part comprising query entities and a results part comprising result entities.

11. The method of claim 8, further comprising:
allowing the user to initiate a new explorative search with one or more entities of any one of the parallel explorative searches a new explorative search.

12. The method of claim 8, further comprising:
allowing the user to initiate a new explorative search with one or more entities of any one of the parallel explorative searches a new explorative search by dragging.

13. The method of claim 8, further comprising:
detecting if the user accesses any of the entities presented to the user; and
indicating to the user contextually connected entities that are presented at the same time with the entity accessed by the user.

14. An apparatus comprising:
a memory comprising operating instructions; and
a processor configured to execute the operating instructions and cause accordingly the apparatus to perform the method of claim 1.

15. An apparatus comprising:
a memory comprising operating instructions; and
a processor configured to execute the operating instructions and cause accordingly the apparatus to perform the method of claim 8.
